(19) United States
(12) Patent Application Publication
(10) Pub. No.: US 2015/0239708 A1
(43) Pub. Date: Aug. 27, 2015

(54) System and Method for Monitoring a Load Bearing Member

(71) Applicant: ThyssenKrupp Elevator AG, Essen (DE)

(72) Inventors: Michael A. Palazzola, Horn Lake, MS (US); Jie Xu, Cordova, TN (US); Peter Feldhusen, Collierville, TN (US); Stephen D. Allen, Middleton, TN (US); Alan Mano Parker, Byhalia, MS (US); Frank Dudde, Collierville, TN (US); Olivia L. Stone, Memphis, TN (US)

(73) Assignee: ThyssenKrupp Elevator AG, Essen (DE)

(21) Appl. No.: 14/190,016

(22) Filed: Feb. 25, 2014

(51) Int. Cl. B66B 5/00; B66B 3/00

(52) U.S. Cl. CPC B66B 5/0025; B66B 3/002; B66B 5/0031

(57) ABSTRACT

A system and method relate to magnetic hoisting member monitoring in an elevator system having an elevator car, a hoisting motor, and a magnetic hoisting member. A monitoring system is used that includes a magnetic field producer, a giant magneto-resistance sensor, a housing unit, and an indicator system. The housing unit is structured to position the magnetic hoisting member of the elevator system relative to the magnetic field producer and the giant magneto-resistance sensor.

### TECHNICAL FIELD

The present invention generally relates to magnetic hoisting member monitoring, and more particularly, but not exclusively, to monitoring a magnetic hoisting member with giant magneto-resistance sensors. Present approaches to magnetic hoisting member monitoring suffer from a variety of drawbacks, limitations, disadvantages and problems including those respecting real time testing, non-destructive tests and others. There is a need for the unique and inventive magnetic hoisting member monitoring apparatuses, systems and methods disclosed herein.

### SUMMARY

One embodiment of the present invention is a unique apparatus and method for magnetic hoisting member monitoring. Other embodiments include apparatuses, systems, devices, hardware, methods, and combinations for magnetic hoisting member monitoring. Further embodiments, forms, features, aspects, benefits, and advantages of the present application shall become apparent from the description and figures provided herewith.

### BRIEF DESCRIPTION OF THE DRAWINGS

It is believed the present invention will be better understood from the following description of certain examples taken in conjunction with the accompanying drawings, in which like reference numerals identify the same elements.

FIG. 1 is a diagram of an exemplary elevator system.

FIG. 2 is a functional block diagram of an exemplary monitoring system.

FIGS. 3A and 3B are diagrams demonstrating magnetic flux leakage with and without a flaw.

FIGS. 4A-4D are diagrams showing exemplary configurations for hoisting members and sensors.

FIG. 5 is a schematic of a exemplary GMR sensor unit.

FIGS. 6A-6C are diagrams of exemplary monitoring configurations.

FIG. 7 is a diagram showing an exemplary indicator system.

FIG. 8 is a diagram of an exemplary configuration having multiple sensor units with an indicator system.

FIG. 9 is a diagram of an exemplary method for use with a version of an exemplary monitoring system.

FIG. 10A is perspective view of an exemplary device for use with an exemplary monitoring system.

FIG. 10B is a perspective view of the device of FIG. 10A, shown with an exemplary hoisting member.

FIG. 11A is a perspective view of another exemplary device for use with an exemplary monitoring system.

FIG. 11B is a perspective view of the device of FIG. 11A, shown with an exemplary hoisting member.

FIG. 12 is a side view of another exemplary device for use with an exemplary monitoring system.

FIG. 13 is a perspective view of another exemplary device for use with an exemplary monitoring system.

FIG. 14A is a side view of another exemplary device for use with an exemplary monitoring system.

FIG. 14B is a perspective view of the exemplary device of FIG. 14A.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description. As will be realized, the invention is capable of other different and obvious aspects, all without departing from the invention. Accordingly, the drawings and descriptions should be regarded as illustrative in nature and not restrictive

With reference to FIG. 1, an exemplary elevator system 100 can include a car 110 and a tension unit 120 connected by a hoisting member 130. A hoisting motor 141 turns a sheave 140 which moves the hoisting member 130. The movement of the hoisting member 130 translates the car 110 and the tension unit 120 through a hoistway 150.

In various applications, a tension unit can include aids for creating tension in a hoisting member. The tension created provides a degree of travel control of the hoisting member and, thereby, travel control of the elevator car. A tension unit can include a passive weight system such as a counterweight or another car. Alternatively, a tension unit can include a mechanical tensioning system such as a spring system or a high traction system with grooved belt and spool designs, for example. For instance, in some versions elevator system 100 can be configured as a drum elevator, where the hoisting member is wound and unwound about a drum to raise and lower the car through the hoistway. Still in some other versions, elevator system 100 can be configured as a roped hydraulic elevator system where a tension unit is used with a hydraulic drive by having the car connected with the tension unit via a hoisting member. In view of the teachings herein, other configurations for elevator system 100 will be apparent to those of ordinary skill in the art.

In the present example, the hoisting member 130 includes at least one load bearing member or rope encased within a common coating. The at least one load bearing member is made up of a plurality of wires and contains a magnetic material. In some embodiments, the hoisting member is implemented as a suspension member. In other embodiments, the hoisting member is implemented as a transmission member, for instance in some examples as a cog belt. Still in some versions the hoisting member is implemented as both a suspension member and a transmission member.

Suspension members operate under tension balancing the weight of the elevator car with the tension unit. As such, suspension members can be referred to as tension members. Suspension members can include, among others, coated flat belts or coated steel wire ropes. Coated suspension members can include magnetic load bearing members coated with a polyurethane material or other envelope or matrix material. In some versions suspension members are not required to be coated.

Analyzing the structural integrity and remaining life of a hoisting member is a function of the safe operation of an elevator system. Integrity degradation of a hoisting member can, as one example, result from cyclic bending around sheaves when the elevator car is translated through the hoistway. The hoisting member can be monitored for integrity degradation. Visual inspection methods for monitoring hoisting members can be limited by an outer portion or coating of the hoisting members. The load bearing members of coated hoisting members can experience damage that is not detected with visual inspection. An embodiment of the present application includes a monitoring system having a magnetic field producer and a giant magneto-resistance (GMR) sensor unit capable of evaluating irregularities and indicating a level or degree of integrity for a magnetic hoisting member which can be coated, or in some instances uncoated. The GMR sensor unit can be a single sensor or an array of sensors.

An embodiment of the present application is capable of identifying the position of an irregularity in a coated magnetic hoisting member along the hoisting member's length, width, and depth. Irregularities can include diameter diminution of cables or wires, broken wires due to fretting wear and stress fatigue, holes, voids, roughing, corrosion, fractures, deformation, and manufacturing defects. A monitoring system of the present application is capable of detecting and determining a degree of irregularity or damage. In some embodiments, the identified area can be further inspected for the type and degree of irregularity. Targeted investigations as a result of this embodiment can reduce the amount of investigation necessary for identifying defects or damage in magnetic hoisting members embedded in or surrounded by matrix materials and for determining the integrity of a length of the hoisting member.

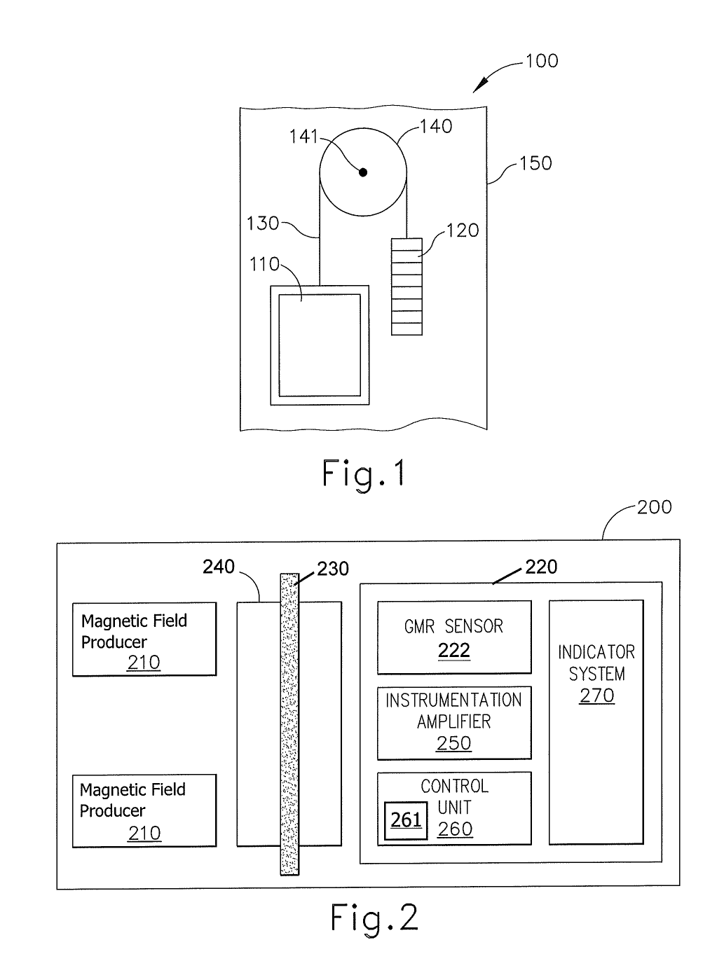

For an embodiment shown in FIG. 2, a monitoring system 200 includes a magnetic field producer 210 and a giant magneto-resistance sensor unit 220. A hoisting member 230 is positioned within the magnetic field 240 of the magnetic field producer 210. The GMR sensor unit 220 is capable of detecting variations in the magnetic field caused by interactions with the hoisting member 230.

Various embodiments of the monitoring system can include an instrumentation amplifier 250, a control unit 260, and an indicator system 270. In one embodiment, the amplifier 250 can amplify a signal produced by the GMR sensor unit 220 in response to the variations in the magnetic field 240. The amplified signal can be transmitted to a control unit 260. The control unit 260 can store information regarding a signal from the GMR sensor unit 220 or activate the indicator system 270 to communicate a representation of the GMR signal. In the version of FIG. 2, magnetic field producers 210 are located separate from GMR sensor unit 220. In some other versions, magnetic field producers 210 are a component of GMR sensor unit 220, for example magnetic field producers 210 and GMR sensor unit 220 are located in a common housing unit.

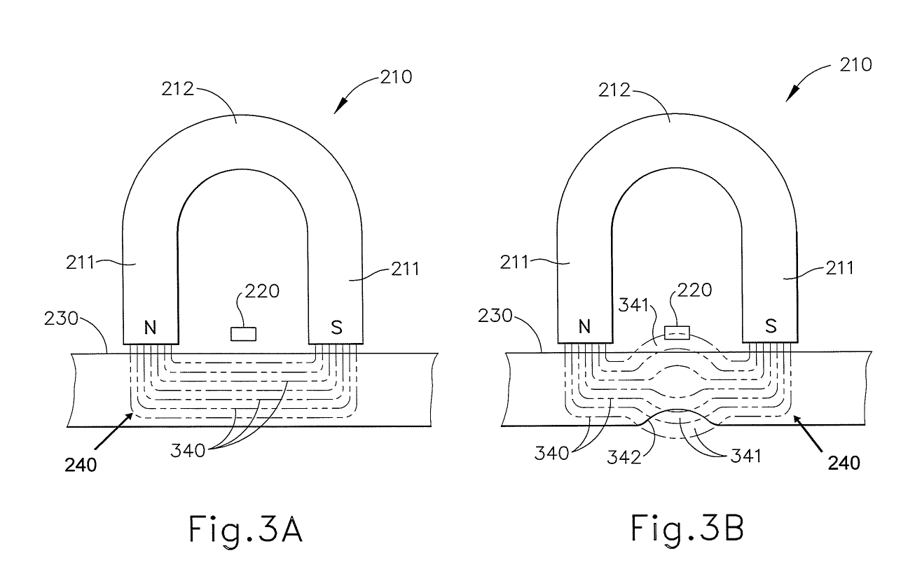

In an embodiment shown in FIGS. 3A and 3B, a magnetic field 240 is produced by a magnetic field producer 210 including two elongated magnets 211. A metal plate 212 can operate as a magnetic conductor to complete the magnetic flux loop of the magnetic field producer 210. A portion of a set of flux lines 340 representing the magnetic field 240 goes through a magnetic field path generally defined by the shape and geometry of the magnetic portion of the hoisting member 230. The magnetic flux 340 leaks or deviates from a standard magnetic field path when an irregularity or localized flaw site 342 (shown in FIG. 3B) interacts with the magnetic field produced by the magnetic field producer 210. The magnetic field 240 produced by the magnetic field producer 210 is capable of penetrating the full depth of the hoisting member 230. Flaws or damage 342 to any magnetic portion of the hoisting member 230 can interact with the magnetic flux 340 and create flux leakage 341 which is detectable by the GMR sensor unit 220. The GMR sensor unit 220 is structured and positioned to sense the magnetic flux leak 341. GMR sensor unit 220 can detect the magnetic flux leak 341 while the hoisting member is stationary or while the hoisting member is moving. By sensing the magnetic flux leak 341, the GMR sensor unit 220 can communicate the presence of the irregularity 342. The communication from the GMR sensor unit 220 can include location or position of the irregularity and the degree of irregularity, for example.

In a further embodiment, the monitoring unit shown in FIGS. 3A and 3B can be structured to align the magnets of a magnetic field producer 210 relative to a hoisting member 230 and a GMR sensor unit 220. In an alternative, a GMR sensor unit 220 can be aligned relative to the magnetic field 240 and the magnetic hoisting member 230. In one embodiment, the GMR sensor unit 220 is aligned perpendicular to the hoisting member 230 and the magnetic field 240. A degree of distortion or noise of the signal from the GMR sensor unit 220 can be related to the degree of perpendicularity of the components. For example, with greater distortion or noise as the degree of perpendicularity between the GMR sensor unit 220 and the hoisting member 230 decreases.

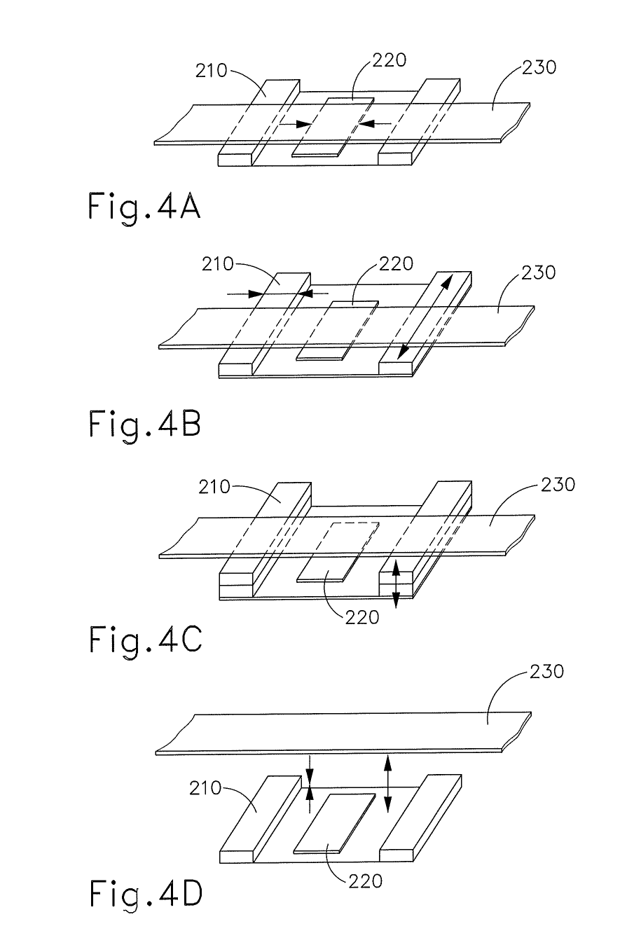

FIGS. 4A-4D illustrate potential variables in determining dimensions for the monitoring system 200. The dimensional variables can be selected in response to the features of an elevator system. Variables can include, but are not limited to, (a) relative position of the magnetic field producer 210 and GMR sensor unit 220 as shown in FIG. 4A, (b) physical proportions of the magnets of the magnetic field producer 210 as shown in FIG. 4B, (c) number of magnets of the magnetic field producer 210 as shown in FIG. 4C, and (d) distance between the hoisting member 230 and the magnetic field producer 210/GMR sensor unit 220 as shown in FIG. 4D. For instance, in some versions, the GMR sensor unit 220 can detect flaws or irregularities in a hoisting member 230 positioned anywhere from zero to two inches away from the GMR sensor unit 220. These variables can be selected or determined in response to application parameters and can vary as the parameters vary within an application and between various applications.

In one embodiment of the present application, a magnetic field producer can include a permanent magnet and a magnetic conductor. In a specific embodiment, the magnets can include an Nd—Fe—B type magnet. In another embodiment, the magnets can have no energy requirement to activate a magnetic field. The magnetic field producer can alternatively or additionally include an electromagnet to induce a magnetic field where the induced magnetic field can be adjusted by increasing or decreasing the coil current.

One embodiment of the present application includes a magnetic field producer with permanent magnets. The magnetic field producer can be positioned on a housing unit and the permanent magnets of the magnetic field producer can be spaced apart with a metal plate to complete a magnetic flux loop. A GMR sensor array can be aligned approximate to the center of the magnetic field produced by the magnetic field producer. Positioning features of the housing unit can guide a moving hoisting member. The housing unit can be placed against the hoisting member or in close proximity without complex guiding features. In some versions the hoisting member and housing unit are configured such that hoisting member moves through a space within the housing unit. A magnetic portion of the hoisting member interacts with the magnetic field from the magnetic field producer when the reluctance of the magnetic portion of the hoisting member is lower than that of air. By way of example only, and not limitation, in a specific embodiment, the hoisting member includes a steel wire where the reluctance is much lower than air, e.g. on the order of a few thousand times lower than air.

Magnetic flux lines representing the magnetic field produced by the magnetic field producer can pass through the hoisting member. The pattern of the magnetic flux lines can be influenced by the shape and geometry of the magnetic portions of the hoisting members. Localized flaws in the magnetic portions of a hoisting member can cause the magnetic flux to leak at the site of the flaw. Magnetic flux leakage can be sensed by the GMR sensor unit 220. In various embodiments, the GMR sensors 222 can generate an output signal 223 in response to changes in the flux pattern created by irregularities in the magnetic hoisting members 230. The output signal 223 from the GMR sensors 222 can be conditioned and amplified by an instrumentation amplifier 250 to produce an amplified output signal 224. The output signal 223 and/or amplified output signal 224 can be stored for retrieval and produce an indication signal 262 for the activation of an LED indicator to indicate damage or deformity in the hoisting member. To determine the degree of irregularity in a hoisting member, an algorithm for determining the remaining life of a hoisting member can be implemented by a control unit 260 in response to the output signal and a determination regarding the integrity of the hoisting member can be stored or communicated directly. Based on the number of irregularities and/or the extent of magnetic flux leakage, the control unit can determine when the breaking strength of a hoisting member falls below a predetermined threshold, for example 60% breaking strength for the entire hoisting member. Based upon the degree of irregularity indicated, a magnetic hoisting member can be further inspected.

A GMR sensor unit in another embodiment can detect flaws in a magnetic load-bearing member based on changes in its magnetic field structure. A GMR sensor or sensor array is capable of detecting magnetic flux leakage resulting from irregularities, localized flaws, loss of metallic cross-sectional area, and loss of metallic volume defects in magnetic load-bearing members encapsulated in a matrix material of a hoisting member. A GMR sensor unit can include a single sensor or an array of sensors. Selection of the size of a GMR sensor array in a GMR sensor unit can be in response to the number, size and geometry of the hoisting member or members being evaluated.

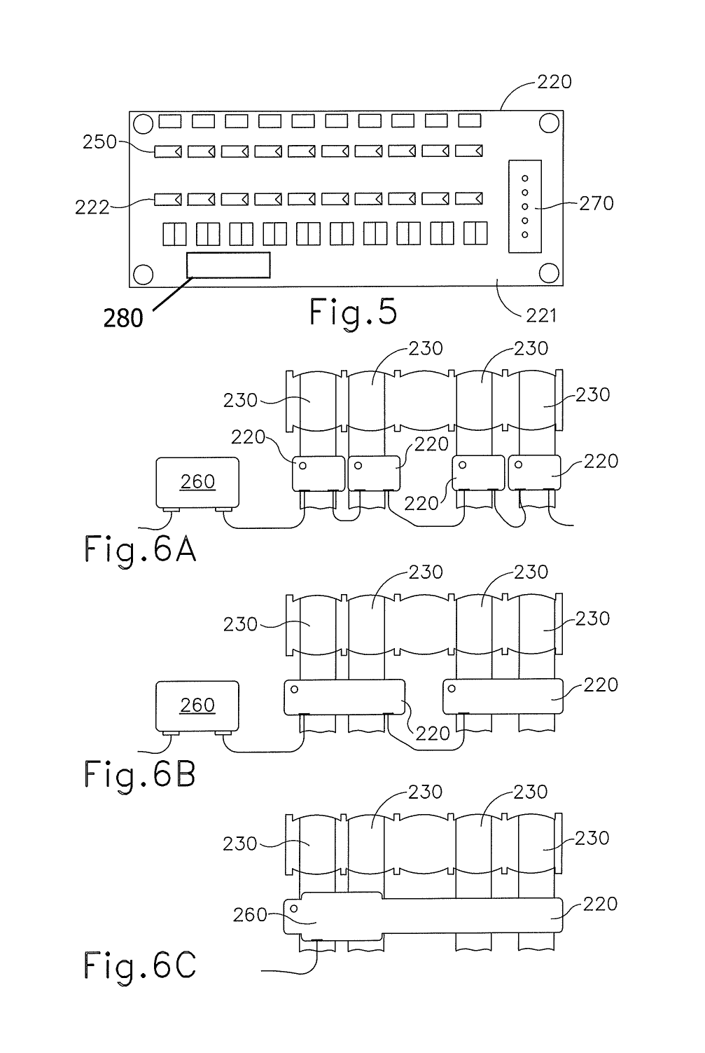

A GMR sensor unit 220 can include an array of sensors 222 as shown in FIG. 5. GMR sensors 222 can be arranged on a printed circuit board 221 in an array. A GMR sensor array layout can be fixed and can be stackable. The array can vary having configurations including linear, arched, staggered, and the like. GMR sensor arrays can be configured to monitor a substantial portion of the dimensions of a hoisting member or members and can be expanded to accommodate variable hoisting member dimensions. An array of sensors can allow positioning of a monitoring system based on the shape and dimension of the hoisting member being monitored. The shape of hoisting member can include, for example, a flat belt, a cog belt, or a round rope.

Giant magneto-resistance is a quantum mechanical magneto-resistance effect observed in a multi-layered thin-film structure. The thin films alternate between ferromagnetic and non-magnetic materials. When a magnetic field is present, the electrical resistance of the layered structure decreases significantly due to the spinning or scattering of electrons in the layers. The GMR effect can operate through non-magnetic materials such as polyurethane coatings, for example. The GMR effect can therefore be applied to magnetic materials coated with or encapsulated in a non-magnetic matrix.

For an embodiment of the present application, a GMR sensor unit is positioned relative to a magnetic load bearing member. The axis of sensitivity of the GMR sensor is orthogonal to the longitudinal axis of the load-bearing member. This arrangement can be optimized for the GMR sensor to process signals indicating leaking flux.

In a specific embodiment, the GMR sensor can be encapsulated in a standard SOIC-8 package and be configured into a Wheatstone bridge. In another specific embodiment, the GMR sensor includes parameters such as a saturation field of 20 Oe, a linear range of 2.014 Oe, a sensitivity of 2-3.2 mV/V-Oe, a resistance of 5 k±20% ohms, SOIC-8 packaging, and a die size of 436×3370 μm.

FIGS. 6A-6C provide various examples of embodiments of hoisting member and monitoring system configurations. A hoisting member can include multiple members in a system. Multiple monitoring systems can be utilized to correspond with the multiple hoisting members. FIG. 6A includes multiple hoisting members 230 each with a GMR sensor unit 220. The GMR sensor units 220 are shown in serial communication with a control unit 260 that is located some distance from GMR sensor units 220. FIG. 6B shows a monitoring system with multiple hoisting members 230 monitored by a single GMR sensor unit 220 with this configuration being repeated. FIG. 6C shows a single GMR sensor unit 220 for a plurality of hoisting members 230. The example in FIG. 6C also includes an integrated control unit 260 with the GMR sensor unit 220. Various other combinations of these examples are also contemplated.

A GMR sensor 222 can generate signals which can be conditioned and/or amplified by an instrumentation amplifier 250. In a further embodiment, an amplifier or array of amplifiers can be included with a GMR sensor unit to amplify sensor output. With an amplifier and GMR sensor mounted on a circuit board, the change in magnetic field can be amplified to provide information relating to the integrity of the magnetic portions of a hoisting member. An instrumentation amplifier can allow for differential input and reduce common mode noise. In one embodiment, an amplifier can be an integrated, micro-power instrumentation amplifier with a high common mode rejection ratio allowing the setting of gain with a single external resistor.

In another embodiment, the monitoring system can include a signal generator 280 to deliver signals from a GMR sensor unit 220 to a control unit 260. The control unit 260 can also receive information from other systems including hoisting member location or position relative to the monitoring system. The control unit 260 can include storage medium 261 to store received information for concurrent processing or processing at a later time. The control unit 260 can further communicate signals, e.g. indication signals, to provide an indication to an operator or maintenance schedule indicating the location of any changes in the magnetic field produced by the monitoring system and/or the degree of irregularity in the hoisting member. Communication can include, but is not limited to, telephone lines, cellular communications, Bluetooth transmission and Wi-Fi and can further include streaming data to electronic devices, such as but not limited to, handhelds, computers, smart phones etc. The communication can be through secure communication protocols.

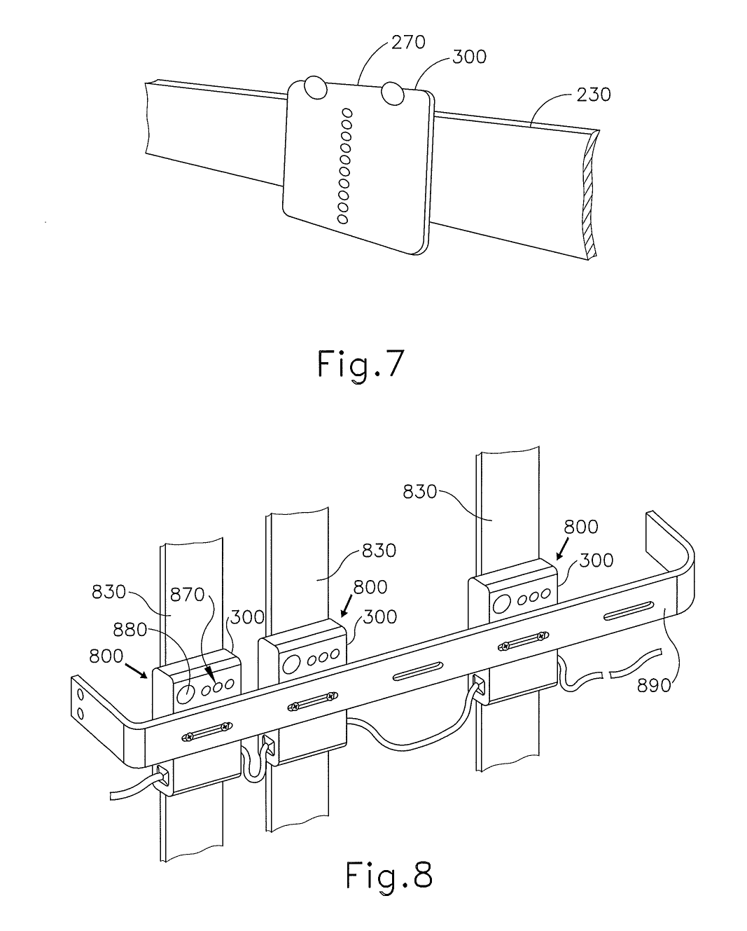

An output signal of a GMR sensor 222 can be used to broadcast the existence and location of a flaw in a magnetic portion of a hoisting member 230 passing through a magnetic field. An output signal broadcast can include communication with a controller 260 or directly indicate the existence and location of the flaw with an indicator system 270 through audible signals, user interface systems, and visual systems such as LEDs, for example. The exemplary LEDs can be driven by an output of an amplifier signal and turned on at the exact location of the flux leakage site along the magnetic load-bearing member. In another embodiment, a controller 260 can directly signal changes in magnetic field readings with indicators 270 local to the monitoring system. Such indicators 270 can include, but are not limited to, indicator lights and LEDs on a housing unit 300 relative to a hoisting member 230 for at least a portion of the monitoring system as shown in FIG. 7.

An embodiment in FIG. 8 shows a plurality of hoisting members 830 and a plurality of monitoring systems 800 to correspond with the hoisting members 830. A support structure 890 positions the monitoring systems 800 relative to the hoisting members 830. A housing unit 300 for the monitoring system 800 positions a magnetic field producer (not shown) and a GMR sensor (not shown) relative to the hoisting members 830. The monitoring systems 800 further include local indicator systems 870 and a local fault reset button 880. In the illustrated example of FIG. 8, indicator systems 870 are depicted as one or more LEDs that comprise a sensory indication as to the integrity of hoisting members 830. The plurality of monitoring systems 800 are partially shown in communication with a central control unit (not shown) with a daisy chain configuration. The control unit can be mounted on the support structure 890 as well. A system of the present application can allow a direct real time detection of damaged magnetic portions of the hoisting member which can be evaluated based on magnetic flux signal strength and form to determine structural integrity and remaining breaking strength of the hoisting member.

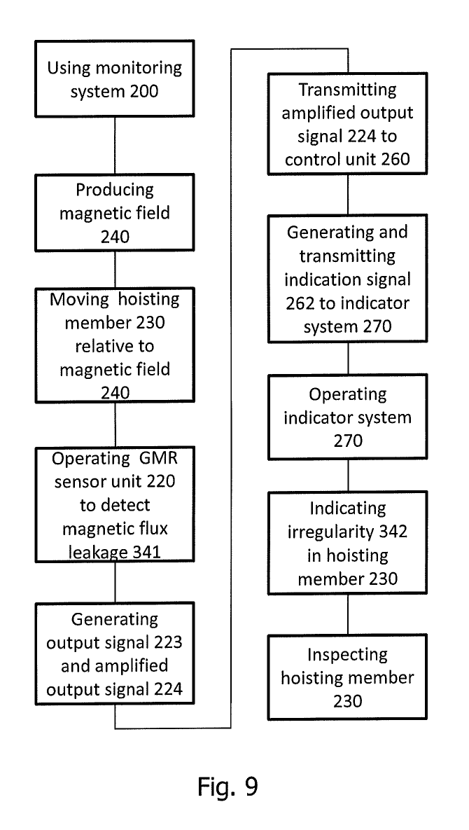

FIG. 9 depicts an exemplary method for using a monitor system as described above. In exemplary step 901 a monitoring system 200 is used, which includes a magnetic field producer 210, GMR sensor unit 220, and housing unit 300. At step 902 magnetic field producer 210 produces magnetic field 240. At step 903 hoisting member 230 is moved relative to magnetic field 240. At step 904 GMR sensor unit 220 is operated to detect magnetic flux leakage 341. At step 905 an output signal 223 is generated from GMR sensors 222 and the output signal can be amplified by instrumentation amplifier 250 to produce amplified output signal 224. At step 906 the amplified output signal is transmitted to control unit 260. At step 907 control unit 260 uses amplified output signal 224 to produce indication signal 262 that is transmitted by control unit 260 to indication system 270. At steps 908 and 909 indication system 270 is operated and indicates the presence of one or more flaws or irregularities 342 in hoisting member 230. At step 910 hoisting member 230 can be inspected based upon the indication of the one or more detected irregularities or flaws. The method here can include various other steps and actions as described above and others that will be apparent to those of ordinary skill in the art in view of the teachings herein. In some versions, not all the method steps or actions shown in FIG. 9 are required. In some versions the steps of FIG. 9 may be performed sequentially, but this is not required in all versions.

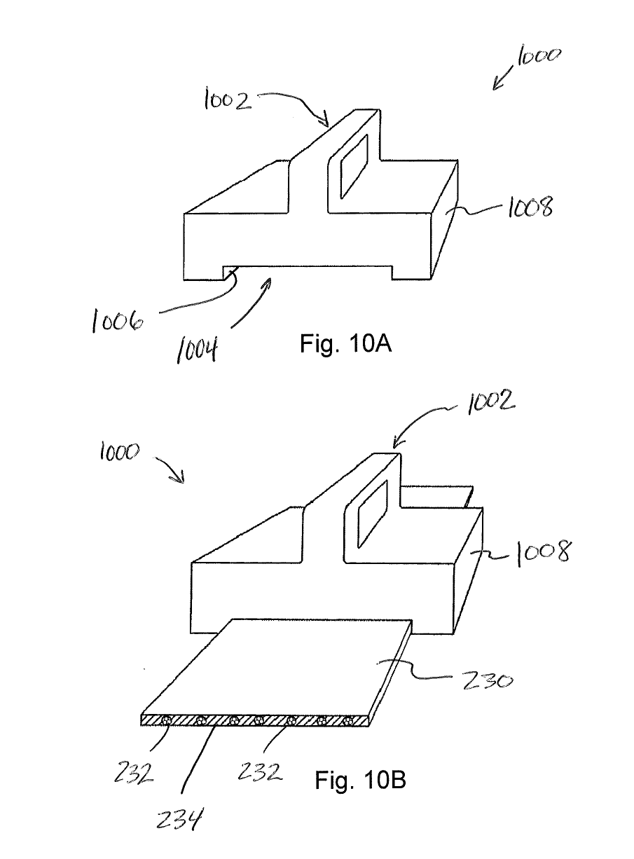

FIGS. 10A-14B depict exemplary embodiments of exemplary devices for use with exemplary monitoring systems described herein. FIGS. 10A and 10B illustrate one such device comprising a hand tool 1000 that can be used to monitor hoisting member 230 comprising at least one magnetic component 232 surrounded by a matrix material 234. Hand tool 1000 is configured to be portable such that a user has a portable monitoring system that can be used to monitor a hoisting member in an elevator installation. In some examples there may be no other monitoring system installed and only the portable system is used. In other versions, portable hand tool 1000 can be used as a redundant check or confirmation tool that can verify the identification of irregularities detected and communicated by a fixed installed monitoring system as described above.

Hand tool 1000 is configured with a handle 1002 and a U-shaped recess 1004. Handle 1002 is located on hand tool 1000 in a location that makes hand tool 1000 easy to grasp. In the illustrated version, but not required in all versions, handle 1002 is located on the opposite side of recess 1004. Recess 1004 is configured with a shape, in this example a U-shape, that complements the shape of hoisting member 230. In the illustrated version hoisting member 230 is configured as a flat belt and this fits within U-shaped recess 1004 such that recess 1004 guides hoisting member 230. In the present example, the sidewalls 1006 of housing 1008 of tool 1000 that define U-shaped recess 1004 serve as positioning members that guide hoisting member 230 as it passes by tool 1000. In the present example, hoisting member 230 is guided by the three sidewalls 1006 of housing 1008 that define recess 1004. In other versions a greater or fewer number of positioning members can be used to guide hoisting member 230. In view of the teachings herein, other ways to guide and/or position hoisting member 230 relative to tool 1000 or housing 1008 of tool 1000 will be apparent to those of ordinary skill in the art.

In the present example, within hand tool 1000, the device includes one or more GMR sensors 222, a magnetic field producer 210, an instrumentation amplifier 250, a control unit 260, and an indicator system 270 as shown in FIG. 2. In some versions of hand tool 1000, one or more of these components can be provided separate from hand tool 1000. For example, in some versions magnetic field producer 210 can be provided in a separate device located on the opposite side of hoisting member 230. In view of the teachings herein, other configurations for the components of hand tool 1000 will be apparent to those of ordinary skill in the art.

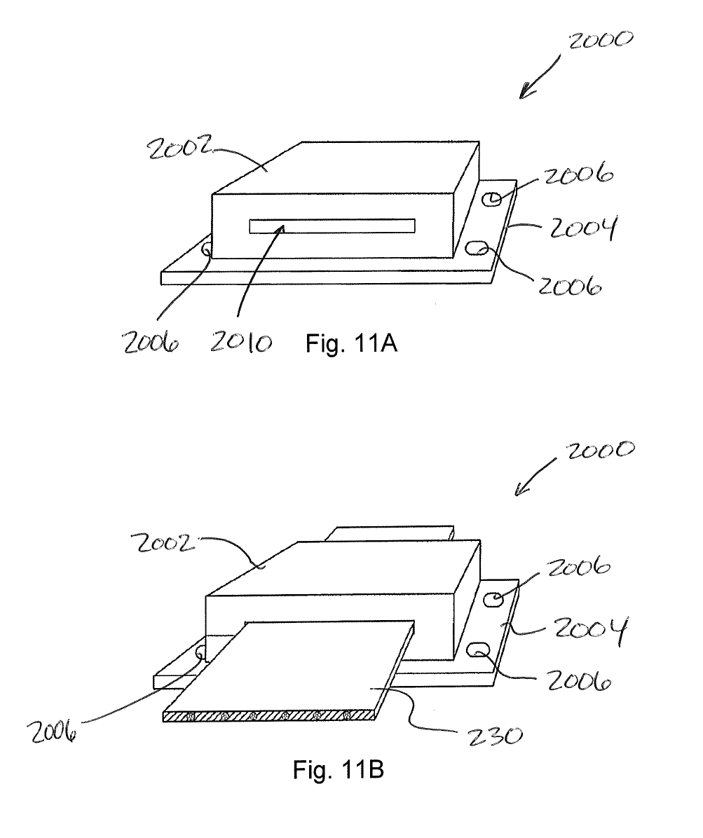

FIGS. 11A and 11B illustrate an exemplary device 2000 for use with an exemplary monitoring system with the device 2000 configured to permit an exemplary hoisting member 230 to pass through device 2000. In the illustrated version, device 2000 comprises a housing 2002 connected with a bracket 2004. Bracket 2004 comprises holes 2006 that can be used to mount device 2000 to a desired location within an exemplary elevator system. Housing 2002 comprises space 2010 that defines a passage or opening through which hoisting member 230 can pass as shown in FIG. 11B.

In the present example, within device 2000 are one or more GMR sensors 222, a magnetic field producer 210, an instrumentation amplifier 250, a control unit 260, and an indicator system 270 as shown in FIG. 2. By way of example only, GMR sensor unit 220 and its components as shown in FIG. 2 can be attached within housing 2002 above where hoisting member 230 passes (on the portion of housing 2002 furthest from bracket 2004). In this example, magnetic field producer 210 can be attached within housing 2002 below where hoisting member 230 passes. In some versions of device 2000, one or more of these components can be provided separate from device 2000. For example, in some versions magnetic field producer 210 can be provided in a separate device. In view of the teachings herein, other configurations for the components of device 2000 will be apparent to those of ordinary skill in the art.

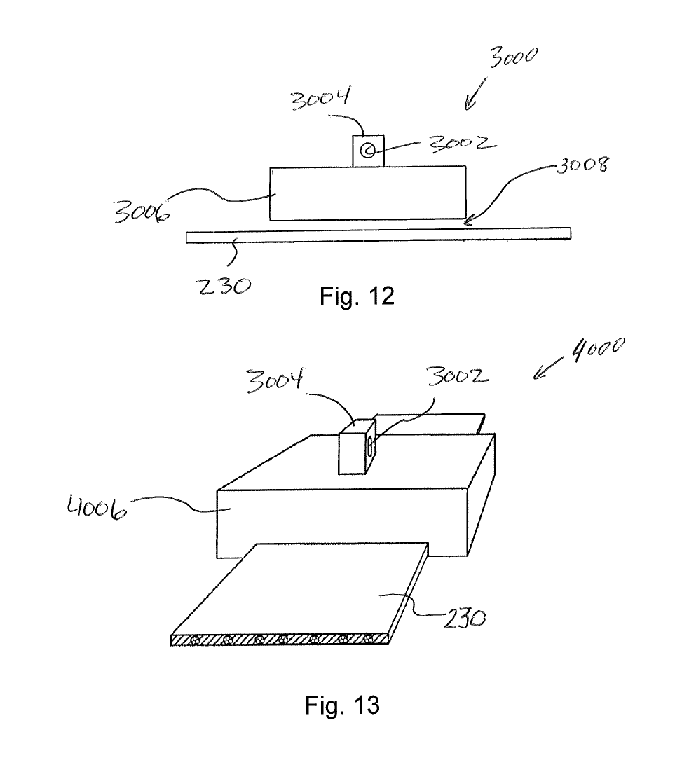

FIGS. 12 and 13 illustrate exemplary device 3000 and device 4000 respectively, each having mounting hole 3002 that is part of bracket 3004 that connects with respective housings 3006, 4006. Mounting hole 3002 allows device 3000, 4000 to be connected with or mounted to another part of the elevator system, for example such as support structure 890 or another similar structure. In each of device 3000 and device 4000, mounting hole 3002 and bracket 3004 are positioned on the opposite sides of respective housings 3006, 4006 from the sides which hoisting member 230 passes by. As shown in these illustrated versions, device 3000 is configured such that hoisting member 230 passes near housing 3006, but is not in contact such that there is an air gap or space 3008 between the underside of housing 3006 and hoisting member 230. Device 4000 is configured with a recess 1004 as described above with respect to FIGS. 10A and 10B.

In the present examples, within each of device 3000 and device 4000 are one or more GMR sensors 222, a magnetic field producer 210, an instrumentation amplifier 250, a control unit 260, and an indicator system 270 as shown in FIG. 2. In some versions of device 3000 and device 4000, one or more of these components can be provided in one or more separate devices from device 3000, 4000. For example, in some versions magnetic field producer 210 can be provided in a separate device. In view of the teachings herein, other configurations for the components of devices 3000, 4000 will be apparent to those of ordinary skill in the art.

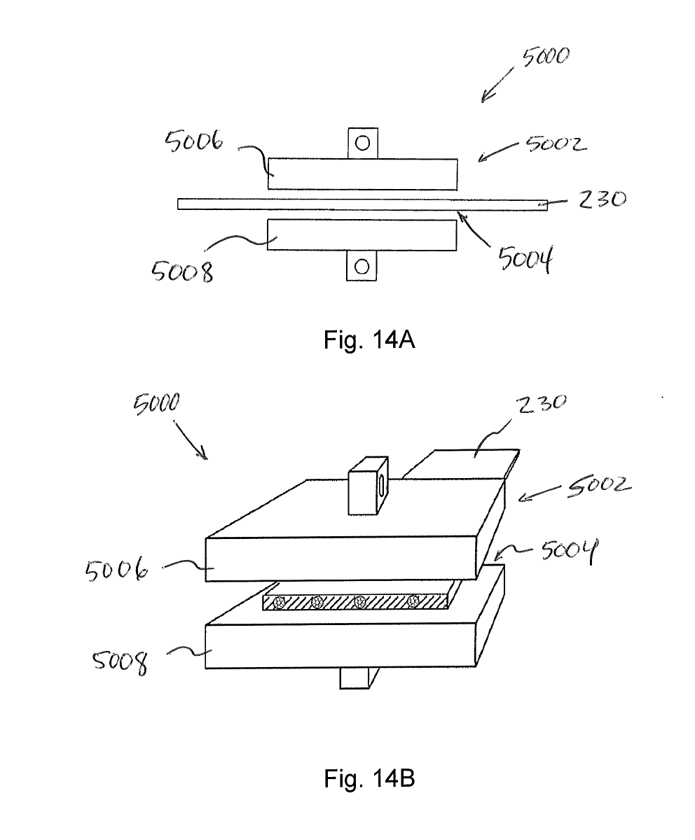

FIGS. 14A and 14B illustrate another exemplary device 5000 having a two-part or split housing 5002. In this configuration, hoisting member 230 is configured to pass between the space 5004 that separates a first housing portion 5006 from a second housing portion 5008. Furthermore device 5000 is configured with brackets 3004 and mounting holes 3002 on each housing portion 5006, 5008 for mounting or connecting each housing portion to other structures of the elevator system as described above.

In the present example, within device 5000 are one or more GMR sensors 222, a magnetic field producer 210, an instrumentation amplifier 250, a control unit 260, and an indicator system 270 as shown in FIG. 2. By way of example only, GMR sensor unit 220 and its components as shown in FIG. 2 can be attached within first housing portion 5006 above where hoisting member 230 passes as illustrated, while magnetic field producer 210 can be attached within second housing portion 5008 below where hoisting member 230 passes as illustrated. In other versions this configuration can be switched. In some versions of device 5000, one or more of these components can be provided separate from device 5000. For example, in some versions magnetic field producer 210 can be provided in a separate device. In view of the teachings herein, other configurations for the components of device 5000 will be apparent to those of ordinary skill in the art.

As described and shown in the above examples, monitoring system 200 is configured to monitor a hoisting member in either a stationary or moving state. Moreover, monitoring system 200 is configured to monitor the integrity of a hoisting member when the hoisting member is in use with an elevator system. In other words, monitoring system 200 provides continuous monitoring of a moving hoisting member used in driving an elevator. As described, this monitoring includes continuous monitoring of magnetic flux leakage attributed to one or more flaws, irregularities, or imperfections in a hoisting member. In such cases with an elevator system equipped with monitoring system 200, monitoring system 200 is configured such that a majority of the hoisting member is positionable proximate to monitoring system 200, i.e. GMR sensor unit 220, during operation of the elevator system. Also as shown and described, monitoring system 200 is configured to detect imperfections within interior components of a hoisting member, and without necessarily contacting the hoisting member directly. Furthermore, monitoring system 200 is configured to accomplish this while having a generally perpendicular orientation with the hoisting member. Also, in some versions, monitoring system 200 is configured along a portion of hoisting member between the ends of hoisting member and/or between the termination devices that hold hoisting member. In such versions a system for monitoring is provided where it is not required to expose the ends of the hoisting member to the monitoring system.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

I/we claim:

1. A system comprising:
a hoisting member for an elevator system, wherein the hoisting member comprises a magnetic component;
a magnetic field producer;
a GMR sensor configured to detect magnetic flux leakage; and
a housing unit configured to position the GMR sensor relative to the hoisting member such that the GMR sensor is operable to detect at least a portion of the magnetic flux leakage, wherein detection of the magnetic flux leakage indicates a flaw or irregularity in the hoisting member.

2. The system of claim 1, wherein the GMR sensor is located within the housing unit.

3. The system of claim 2, wherein the magnetic field producer is located within the housing unit.

4. The system of claim 1, further comprising a control unit configured to process an indication signal in response to an output signal from the GMR sensor, wherein the indication signal includes at least one of a position of the irregularity and a degree of the irregularity.

5. The system of claim 4, further comprising a tangible storage medium configured to receive the indication signal in response to the output signal from the GMR sensor.

6. The system of claim 4, further comprising an amplifier structured to amplify the output signal from the GMR sensor.

7. The system of claim 4, further comprising an indicator system capable of providing a sensory indication in response to the indication signal.

8. The system of claim 4, wherein the control unit transmits the indication signal to an operator or maintenance schedule.

9. The system of claim 1, wherein the hoisting member is in motion and travels through a magnetic field produced by the magnetic field producer, and the GMR sensor is stationary.

10. A method of monitoring a hoisting member of an elevator system, the method comprising:
using a monitoring system having
a magnetic field producer,
a GMR sensor, and
a housing unit configured to position the GMR sensor relative to the hoisting member, wherein the hoisting member comprises a magnetic component;
producing a magnetic field with the magnetic field producer;
operating the GMR sensor; and
indicating one or more irregularities in the hoisting member in response to operating the GMR sensor.

11. The method of claim 10, further comprising:
moving the hoisting member relative to the magnetic field producer such that the hoisting member is exposed to a magnetic field produced by the magnetic field producer.

12. The method of claim 10, further comprising:
producing an indication signal in a control unit in response to receiving an output signal from the GMR sensor, wherein the indication signal includes at least one of a position and a degree of the one or more irregularities in the hoisting member.

13. The method of claim 12, further comprising:
amplifying the output signal to create an amplified output signal;
transmitting the amplified output signal to an indicator system;
operating the indicator system in response to the amplified output signal; and
indicating the one or more irregularities in response to the operating of the indicator system.

14. The method of claim 13, further comprising:
inspecting the hoisting member in response to the indicating the one or more irregularities.

15. The method of claim 10, further comprising:
using a plurality of monitoring systems; and
moving a plurality of hoisting members relative to the plurality of monitoring systems such that the plurality of hoisting members are exposed to the magnetic fields produced by the magnetic field producers of the plurality of monitoring systems.

16. An elevator system comprising:
an elevator car;
a movable hoisting member comprising a magnetic component and configured to travel through a magnetic field;
a hoisting motor assembly configured to drive the elevator car by moving the hoisting member through the magnetic field;
a monitoring system including
a magnetic field producer configured to produce the magnetic field,
a GMR sensor configured to detect magnetic flux leakage from the magnetic field, and
a housing unit configured to position the GMR sensor stationary relative to the movable hoisting member, and within a range where the GMR sensor can detect the magnetic flux leakage from the magnetic field, wherein the detected magnetic flux leakage is attributed to one or more imperfections in the hoisting member; and
an indicator system configured to signal the presence of the one or more imperfections in the hoisting member.

17. The system of claim 16, wherein the monitoring system further includes a control unit configured to process an indication signal in response to an output signal from the GMR sensor, wherein the indication signal includes at least one of a position of the imperfection and a degree of the imperfection of the hoisting member.

18. The system of claim 17, wherein the indicator system is located remotely from the elevator system and the monitoring system.

19. Thy system of claim 16, wherein the hoisting member comprises at least one magnetic load bearing member surrounded by a non-magnetic coating.

20. The system of claim 16, wherein the housing unit is configured to retain the GMR sensor and provide a space by which the hoisting member can travel such that the GMR sensor and the hoisting member are substantially oriented orthogonally relative to one another.
